(19) United States
(12) Patent Application Publication
(10) Pub. No.: US 2011/0160048 A1
(43) Pub. Date: Jun. 30, 2011

(54) COATING METHOD FOR STRUCTURED CATALYSTS

(76) Inventors: Nariman BOUMENDJEL, Amsterdam (NL); John Graham Buglass, Amsterdam (NL); Yvette Louise Jenkins, Amsterdam (NL); Thijmen Simon Van Klei, Amsterdam (NL); Gerardus Petrus Lambertus Niesen, Amsterdam (NL); David Schaddenhorst, Amsterdam (NL); Ronald Jan Schoonebeek, Amsterdam (NL)

(21) Appl. No.: 12/969,205

(22) Filed: Dec. 15, 2010

(30) Foreign Application Priority Data
Dec. 29, 2009 (EP) 09180864.2

(51) Int. Cl. B01J 37/02; B01J 37/08; B01J 35/10

(52) U.S. Cl. 502/300; 502/100

(57) ABSTRACT

The invention relates to a method for applying a layer comprising a carrier material to a highly porous support, said method comprising the following steps: (a) applying a mixture comprising a liquid and a carrier material to a highly porous support having a size of at least 1 mm and a porosity within the range of between 50 and 98 volume %; (b) centrifuging and spinning the support; (c) drying and/or calcining the support.

This application claims the benefit of European Application No. 09180864.2 filed Dec. 29, 2009, which is incorporated herein by reference.

### BACKGROUND OF THE INVENTION

The present invention relates to a method for coating a support for a catalyst. It especially relates to a method for coating a structured catalyst support. The invention further relates to the catalyst made and the use of this catalyst.

As is explained in WO 2005/075065, Fischer-Tropsch processes are often used for the conversion of gaseous hydrocarbon feed stocks into liquid and/or solid hydrocarbons. The feed stock, e.g. natural gas, associated gas, coal-bed methane, residual (crude) oil fractions, coal and/or biomass is converted in a first step to a mixture of hydrogen and carbon monoxide, also known as synthesis gas or syngas. The synthesis gas is then converted in a second step over a suitable catalyst at elevated temperature and pressure into paraffinic compounds ranging from methane to high molecular weight molecules comprising up to 200 carbon atoms, or, under particular circumstances, more.

Numerous types of reactor systems have been developed for carrying out the Fischer-Tropsch reaction. Fischer-Tropsch reactor systems include fixed bed reactors, in particular multi-tubular fixed bed reactors, fluidized bed reactors, such as entrained fluidized bed reactors and fixed fluidized bed reactors, and slurry bed reactors, such as three-phase slurry bubble columns and ebullated bed reactors.

The Fischer-Tropsch reaction is very exothermic and temperature sensitive with the result that careful temperature control is required to maintain optimum operation conditions and desired hydrocarbon product selectivity. Bearing in mind the very high heat of reaction which characterizes the Fischer-Tropsch reaction, the heat transfer characteristics of a catalyst are important.

### SUMMARY OF THE INVENTION

The current invention relates to a highly porous catalyst suitable for use in an exothermic reaction. Such a catalyst has very good heat transfer characteristics. The catalyst normally comprises a support and a catalyst material. The support has a highly porous structure. The catalyst material comprises a catalytically active metal and a carrier.

Application of the carrier material to the highly porous support is often performed by a coating method, such as spray-coating or dip-coating. A problem with most coating methods is controlling the application of the coating.

It is thus desired to have an improved method for applying a carrier material to a highly porous support. applying a carrier material to a highly porous support.

Accordingly, the present invention provides a method for applying a layer comprising a carrier material to a highly porous support, said method comprising the following steps:
(a) applying a mixture comprising a liquid and a carrier material to a highly porous support;
(b) centrifuging and spinning the support;
(c) drying and/or calcining the support.

Generally, some of the mixture applied in step (a) will be removed from the porous support by means of the centrifuging and spinning of the support in step (b).

### BRIEF DESCRIPTION OF THE DRAWING

FIG. 1 is a horizontal cross-section of a rotating wheel with four devices that can spin around their own axis.

### DETAILED DESCRIPTION OF THE INVENTION

The highly porous support to which the layer comprising a carrier material is applied has a size of at least 1 mm. Supports having a size of at least 1 mm are defined as supports having a longest internal straight length of at least 1 mm.

The highly porous support to which the layer comprising a carrier material is applied has a porosity within the range of between 50 and 98 volume %. Preferably, the highly porous support to which the layer comprising a carrier material is applied preferably has pores with a size of more than 10 μm.

A method according to the present invention has several advantages. With a method using centrifuging and spinning, a very even layer comprising carrier material can be obtained. Further, the thickness of the layer comprising carrier material can be accurately controlled.

The method of the present invention may be repeated several times, whereby a thin layer comprising carrier material is applied each time. This way a good and strongly adhered layer comprising a carrier material may be applied to the highly porous support.

When using a metal oxide as carrier material, such as titania, silica or alumina, each applied layer comprising carrier material may be dried and/or calcined before the next layer is applied.

When applying a mixture comprising a liquid and a carrier material to a highly porous support, any suitable application method may be used. For example, the liquid and carrier material may be applied by means of dip-coating and/or spray-coating. Preferably the liquid and carrier material applied by means of dip-coating to the highly porous support in step (a).

In an even more preferred embodiment of the method of the current invention, the mixture comprising a liquid and a carrier material is applied to a highly porous support in step (a) using a method comprising the following steps:
(i) placing the highly porous support at least partially in the mixture comprising a liquid and a carrier material;
(ii) applying vacuum for more than 1 minute to the mixture that comprises at least a part of the porous support;
(iii) taking the porous support out of the mixture.

This preferred embodiment has several advantages as compared to conventional techniques for applying a layer comprising a carrier material to a highly porous support such as spray-coating and dip-coating under atmospheric pressure in air. One advantage is that it is possible to apply a sufficiently high amount of carrier material to the support in a lower number of steps. Another advantage is that a better wetting can be obtained. A further advantage is that air bubbles trapped in the mixture comprising a liquid and a carrier material can be removed before the porous support is taken out of the mixture. This method is especially advantageous when applying a mixture comprising a liquid and a carrier material to a complex structured support, such as a foam or a relatively dense metal wire support. A layer comprising a carrier material can be applied at the inside of a complex structured support, even when a relatively viscous mixture comprising carrier material and liquid is used.

When a highly porous support is placed in a mixture comprising a liquid and a carrier material in step (i), preferably at least 50%, more preferably at least 80%, most preferably at least 95% of the porous support is placed in the mixture. In a highly preferred embodiment the whole support is dipped into the mixture. The highly porous support may be placed at least partially in a mixture comprising a liquid and a carrier material under atmospheric pressure. The highly porous support is preferably rotated in the mixture. Rotation in the mixture is preferably performed for several minutes, for example for 10 minutes. Especially when the mixture is relatively viscous and the highly porous support is a complex structured support, such as a foam or a relatively dense metal wire support, rotating the support in the mixture is desirable; during the rotation the viscous mixture penetrates more easily into the pores of the support.

In a preferred embodiment, the porous support is rotated in the mixture before the application of vacuum in step (ii). Additionally or alternatively, the support may be rotated during the application of vacuum in step (ii).

The vacuum applied in step (ii) may have any value which is suitable to withdraw trapped air bubbles from the mixture comprising a liquid and a carrier material. Preferably the vacuum applied in step (ii) is in the range of between 0 mbar absolute to 100 mbar absolute.

Vacuum is applied for more than 1 minute to the mixture that comprises at least a part of the porous support in step (ii). Additionally, vacuum may be applied during step (i).

When vacuum is applied to a mixture that comprises at least a part of the porous support in step (ii), this may be performed by keeping the mixture under vacuum for more than 1 minute after placing the highly porous support at least partially in the mixture in step (i).

Alternatively, step (i) may be performed at atmospheric pressure, and vacuum may then be applied in step (ii) by putting the mixture with the porous support under vacuum by removing air and subsequently keep the support with carrier material under vacuum for more than 1 minute.

In a preferred embodiment, the porous structure is placed at least partially in the mixture comprising a liquid and a carrier material in step (i), then the porous structure is rotated in the mixture for several minutes, and then vacuum is applied in step (ii) for at least 1 minute.

In step (ii), vacuum is applied for more than 1 minute, preferably for more than 5 minutes. In step (ii), vacuum preferably is applied for less than 5 hours, preferably less than 60 minutes.

In case of trapped air bubbles in the mixture, it is often possible to see the air bubbles leave the mixture during the application of vacuum in step (ii). The application of vacuum preferably is continued as long as bubbles are surfacing.

After application of vacuum to the support with carrier material in step (ii), the porous support is taken out of the mixture in step (iii). Step (iii) may be performed under atmospheric pressure. In a preferred embodiment, the mixture comprising at least a part of the highly porous structure is subjected to vacuum in step (ii), then the vacuum is turned off, and then the porous support is taken out of the mixture under atmospheric pressure in step (iii).

It was found that the mixture comprising liquid and carrier material that is applied in step (i) may be relatively viscous. An advantage of using a relatively viscous mixture in step (i) is that more carrier material can be applied per application step. Hence, less application steps are required to obtain the required amount of carrier material on the support.

An application step (a) using a method comprising the steps (i), (ii) and (iii) is especially advantageous when applying a relatively viscous mixture to a highly porous support that has a relatively high density and a relatively high surface area. During the vacuum step (ii) the wetting is improved, and possibly trapped air bubbles may be removed. In an application step (a) using a method comprising the steps (i), (ii) and (iii) a relatively viscous mixture penetrates the porous support properly.

The liquid used in step (a) of a method according to the present invention preferably is a liquid with which the carrier material can form a mixture rather than a solution. Most preferably it is possible to prepare a slurry from the liquid and carrier material. In a slurry, solid carrier particles are dispersed in the liquid. The slurry may be a suspension of solid carrier material in the liquid.

Examples of suitable liquids that can be used in step (a) are water and alcohol. Preferably the liquid used in step (a) is water.

The mixture comprising a liquid and a carrier material that is applied to a highly porous support in step (a) may comprise additional ingredients. For example, the mixture may comprise a catalytically active metal or precursor therefor. Additionally or alternatively, the mixture may comprise a promoter or precursor therefor. Additionally or alternatively, the mixture may comprise a dispersant. A suitable dispersant for a mixture comprising water and titania is, for example, an ammonium salt of a lactic acid titanate chelate. An example of a commercially available ammonium salt of a lactic acid titanate chelate is Tyzor® LA (ex DuPont).

After application of the mixture comprising a liquid and a carrier material to the support in step (a), it is desired to remove some of it. This is performed by centrifuging and spinning the support in step (b).

The speed of centrifuging preferably is in the range of between 200 and 5000 rotations per minute (rpm). This may be performed using, for example, a commercially available centrifuge or a rotating wheel.

The support is preferably spun around its own axis at a speed in the range of between 200 and 5000 rotations per minute (rpm). This may be performed using, for example, a stirring rod, a drill, or a holder that can spin around its own axis.

In step (b) of the method of the current invention, the support most preferably is centrifuged and spun around its own axis at the same time. In that case the speed of centrifuging preferably is in the range of between 200 and 5000 rpm, more preferably in the range of between 300 and 1500 rpm, and the speed of the spinning preferably is in the range of between 50 and 2000 rpm, more preferably in the range of between 100 and 500 rpm.

When both centrifuging and spinning are used at the same time, the support may, for example, be attached to a centrifuge or rotating wheel with a device that can spin around its own axis. In that case the support is fixated to the device that can spin around its own axis. While the centrifuge or wheel is rotating, the support is moving along with the centrifugation movement, and at the same time the support is rotated around its own axis.

A centrifuge or rotating wheel with a device that can spin around its own axis may have several configurations. The device that can spin around its own axis may be on top of the centrifuge or rotating wheel. Alternatively, the device that can spin around its own axis may be hanging at the underside of the centrifuge or rotating wheel. The device that can spin around its own axis is preferably placed near the periphery of the centrifuge or the rotating wheel. This way the speed of the centrifuge is used most effectively. The device that can spin around its own axis may be placed substantially vertically or tilted, and it may even change the degree of tilting during step (b) of the present invention. The centrifuge or rotating wheel and the device that can spin around its own axis may rotate in the same direction or in opposite directions. For example, the centrifuge or rotating wheel may rotate clockwise, and the device that can spin around its own axis may then either move clockwise or anti-clockwise. The centrifuge or rotating wheel and the device that can spin around its own axis may rotate at the same speed or at different speeds. Preferably the centrifuge or rotating wheel is moving with a higher number of rotations per minute than the device that can spin around its own axis.

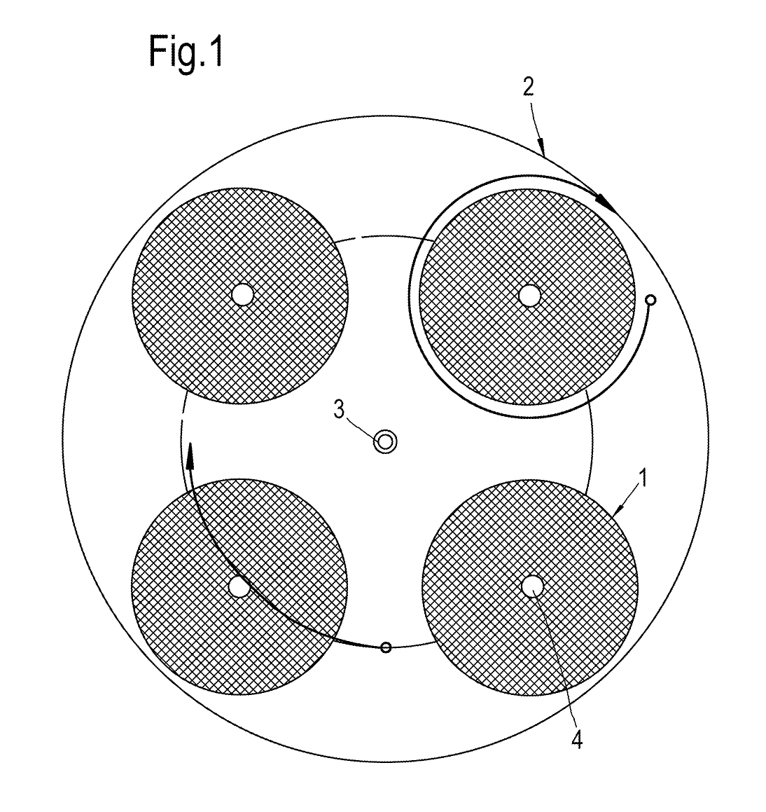

A specific embodiment of the invention will now be explained in more detail with reference to the drawing. FIG. 1 shows an example of a device suitable to centrifuge and spin the support at the same time in step (b) of a process according to the invention.

FIG. 1 is a horizontal cross-section of a rotating wheel with four devices that can spin around their own axis.

Holders (1), which are suitable to hold a support, for example a metal gauze body, are eccentrically positioned on a rotating wheel (2). The wheel can spin around its own centre; this is the primary spinning centre (3). The holders (1) can spin around their own centers; these are secondary spinning centers (4). The bold arrows indicate possible directions for the rotation; in this case the rotating wheel and the holders rotate clockwise.

One advantage of using both centrifuging and spinning in step (b) of the present invention is that a more even layer of the mixture comprising a liquid and a carrier material on the support can be obtained as compared to a method in which only centrifuging or only spinning is used. Another advantage is that the layer of the mixture comprising a liquid and a carrier material on the support will be more equally deposited over the cross section of the support in a horizontal plane. These advantages are most pronounced when centrifuging and spinning in step (b) are performed at the same time, for example using a device as shown in FIG. 1.

The temperature during step (a), which step may comprise steps (i), (ii) and (iii) as described above, and the temperature during step (b) can be any suitable temperature. Preferably, the temperature during these steps is not below the freezing point of the liquid. Preferably, the temperature during these steps is not above the boiling point of the liquid. Preferably the temperature during these steps is in the range of between 5 and 70° C., more preferably between 20 and 60° C.

If the support with mixture is dried, the temperature during drying in step (c) can be any suitable temperature. It may be performed at room temperature. Drying in step (c) may be performed under vacuum. Preferably the temperature during drying is in the range of between 70 and 150° C., more preferably between 100 and 140° C. If the support is calcined, the calcination temperature may be adjusted to the nature of the carrier material. Calcination in step (c) is preferably performed at a temperature in the range of between 250 to 750° C., preferably between 270 to 570° C.

The method of the current invention may be repeated until a sufficiently high amount of carrier material has been applied to the highly porous support.

After the method of the current invention, or after repeatedly performing the method of the current invention, a catalytically active metal or precursor therefor may be applied, for example by means of impregnation. Similarly, a promoter or precursor therefor may be applied, for example by means of impregnation. If a catalytically active metal or precursor therefor or a promoter or precursor therefor is present in the mixture used in step (a), it may not be necessary to apply it after the method of the current invention.

It was found that the mixture comprising liquid and carrier material that is applied in step (a) may be relatively viscous. When a mixture comprising water and titania is used in step (a) of a method according to the present invention, the mixture may have a Loss on Ignition (LOI) of about 70% to 80%.

Loss on Ignition (LOI) numbers provided in this specification have been determined as follows:
measuring the weight of a sample;
thermal treatment of the sample for 1 hour at 500° C.;
measuring the weight of the sample;
calculating the weight loss corresponding to

LOI in %=(Pₒ−P₁)/Pₒ

in which
Pₒ=initial weight of the sample and
P₁=weight of the sample after thermal treatment for 1 hour at 500° C., and cooling to ambient temperature in an anhydrous enclosure.

Using the method of the present invention, preferably at least 90%, more preferably at least 95%, most preferably at least 99% of the surface of the highly porous support is covered with carrier material.

Using the method of the present invention, optionally after repeating the method, preferably a layer of carrier material on the highly porous support is obtained with an average thickness in the range of between 20 to 100 micrometers, more preferably between 25 to 80 micrometers, most preferably between 25 to 60 micrometers. The thickness of the layer of carrier material may be estimated by measuring the weight increase of the highly porous support after application of the carrier material.

Additionally or alternatively, the average thickness of a layer comprising carrier material on a highly porous support can be estimated by measuring the volume of the support before and after application of the layer comprising carrier material. The volumes may be determined by putting the support, and after application and drying and/or calcining the support with a layer comprising carrier material, in a container with a certain volume, and then measuring the amount of liquid needed to fill the container.

Additionally or alternatively, the thickness and the quality of a layer comprising a carrier material on a highly porous support can be determined as follows. A coated support may be embedded in a resin, and then cut. The cuts can be studied using a scanning electron microscope (SEM) or a transmission electron microscope (TEM) or computer aided tomography (CAT).

The highly porous support to which the layer comprising a carrier material is applied has a size of at least 1 mm. Preferably the highly porous support has a size of less than 10 m, more preferably less than 5 m. The highly porous support used in a method according to the present invention may be of a regular or an irregular shape, or a mixture thereof. Such include cylinders, cubes, spheres, ovoids, and other shaped polygons.

In a preferred embodiment the highly porous supports have a form or shape selected from the group consisting of gauze, honeycomb, monolith, sponge, mesh, webbing, foil construct and woven mat form, or any combination of these.

The highly porous support may be a combination of forms such as those listed above. For example, the highly porous support may be made up of a honeycomb shaped material and have a circular outer shape. Another example is a cylinder made from woven mat.

The highly porous support may be made from any inert material capable of withstanding conditions within the reactor. The highly porous support may be made from one or more refractory oxides, for example titania, silica and/or alumina. The highly porous support is preferably made from metal, more preferably from stainless steel, iron and/or copper.

The surface of the highly porous support may be smooth or rough. Preferably the support is cleaned before the carrier material is applied. When the support is made from metal, the support is preferably degreased before the carrier material is applied, for example by washing it with a mixture of toluene and acetone.

Suitable highly porous supports, to which the carrier material can be applied, can be prepared in-house or obtained commercially. An example of a producer of suitable highly porous supports is the Fraunhofer-Institute for Manufacturing and Advanced Materials in Dresden, Germany. The Fraunhofer-Institute advertises and sells, for example, melt extracted metallic fibres, and highly porous fibre structures that can be cylindrically or spherically shaped. Another example of a producer of suitable porous bodies is Rhodius. Rhodius advertises and sells, for example, knitted wire meshes of various shapes, with various thicknesses and with various densities.

The porosity within the highly porous support, i.e. the internal voidage of the highly porous support before application of the carrier material on the highly porous support, is more than 50 volume % and less than 98 volume %; preferably the internal voidage is less than 95 volume %; preferably the internal voidage is more than 60 volume %, more preferably more than 70 volume %, even more preferably more than 80 volume %, and most preferably more than 90 volume %, calculated on the circumferential volume of the highly porous support.

The current invention additionally relates to a highly porous catalyst suitable for use in an exothermic reaction. The current invention additionally relates to the use of such catalyst in a Fischer-Tropsch reaction. The catalyst comprises a highly porous support and a catalyst material. The support has a highly porous structure. The catalyst material comprises a carrier and a catalytically active metal.

The catalyst may be made using the method of the current invention. As mentioned above, the catalytically active metal or a precursor therefor may be applied together with the carrier material in step (a). Additionally or alternatively, the catalytically active metal may be applied after the method of the present invention, for example by impregnating the support plus carrier with a solution comprising the catalytically active metal or a precursor therefor.

A precursor of a catalytically active component can be made catalytically active by subjecting it to hydrogen or a hydrogen containing gas.

A catalyst is defined for this specification as an object that either is catalytically active, or that can be made catalytically active by subjecting it to hydrogen or a hydrogen containing gas. For example, metallic cobalt is catalytically active in a Fischer-Tropsch reaction. In case the catalyst particle comprises a cobalt compound, the cobalt compound can be converted to metallic cobalt by subjecting it to hydrogen or a hydrogen containing gas. Subjection to hydrogen or a hydrogen containing gas is sometimes referred to as reduction or activation.

When a catalyst is referred to as comprising a certain amount of catalytically active metal, reference is made to the amount of metal atoms in the catalyst which are catalytically active when in metallic form. A catalyst comprising a cobalt compound, for example, is thus considered as a catalyst having a certain amount of catalytically active cobalt atoms. A catalyst thus comprises a certain amount of catalytically active metal, regardless of its oxidation state.

The porosity of the catalyst, i.e. including the carrier material and the highly porous support, is at least 50 volume % and is preferably at least 65 volume %, more preferably around 85 volume %, calculated on the circumferential volume of the catalyst.

The external voidage of one or more catalysts according to the present invention, i.e. including the carrier material and the highly porous support(s), in situ in a reactor is in the range of between 5 and 60 volume %, preferably less than 40 volume %, more preferably about 20 volume %, calculated on the reactor volume outwith the circumferential volume(s) of the catalyst(s).

The porosity of the catalyst, in other words the open volumes within the catalyst, must be sufficient to facilitate efficient through-flow of reactants, while at the same time the specific surface area of each catalyst should be as large as possible to increase exposure of reactants to the catalyst material.

The carrier material may be applied to the highly porous support as a thin layer in a method according to the present invention. The carrier material layer is preferably sufficiently thin to avoid diffusional mass transport limitation (decrease of CO and/or hydrogen partial pressure and/or unfavorable change of the hydrogen/carbon monoxide-ratio within the catalyst layer) of the syngas components within the carrier material layer. The thickness of the carrier material layer is preferably increased up to the onset of mass transport limitation. There is no upper limit to the thickness of the carrier material layer onto the highly porous support other than the remaining voidage after application of the carrier material on the highly porous support for hydrodynamic reasons.

Preferably the carrier material is applied as a layer to the highly porous support, typically in a thickness of from about 1 to about 300 micrometers and preferably from about 5 to about 200 micrometers.

It is preferred that the carrier material fraction of the catalyst is at least about 1% by volume and preferably at least about 4% by volume (with reference to the volume of the catalyst), with a preferred maximum of 25% by volume.

General methods of preparing catalyst or materials are known in the art, see for example U.S. Pat. No. 4,409,131, U.S. Pat. No. 5,783,607, U.S. Pat. No. 5,502,019, WO 0176734, CA 1166655, U.S. Pat. No. 5,863,856 and U.S. Pat. No. 5,783,604. These include preparation by co-precipitation and impregnation. Such processes could also include sudden temperature changing.

The catalyst may comprise one or more metals or metal oxides as promoters, more particularly one or more d-metals or d-metal oxides.

Preferably the catalyst is a Fischer-Tropsch catalyst. Fischer-Tropsch catalysts are known in the art, and typically include a Group 8-10 metal component, preferably cobalt, iron and/or ruthenium, more preferably cobalt.

References to “Groups” and the Periodic Table as used herein relate to the new IUPAC version of the Periodic Table of Elements such as that described in the 87^{th} Edition of the Handbook of Chemistry and Physics (CRC Press).

Suitable metal oxide promoters may be selected from Groups 2-7 of the Periodic Table of Elements, or the actinides and lanthanides. In particular, oxides of magnesium, calcium, strontium, barium, scandium, yttrium, lanthanum, cerium, titanium, zirconium, hafnium, thorium, uranium, vanadium, chromium and manganese are most suitable promoters.

Suitable metal promoters may be selected from Groups 7-10 of the Periodic Table. Manganese, iron, rhenium and Group 8-10 noble metals are particularly suitable, with platinum and palladium being especially preferred.

Any promoter(s) is typically present in an amount of from 0.1 to 60 parts by weight per 100 parts by weight of carrier material. It will however be appreciated that the optimum amount of promoter(s) may vary for the respective elements which act as promoter(s).

Typically the carrier material is a porous inorganic oxide, preferably alumina, silica, titania, zirconia or mixtures thereof. The most preferred carrier material is titania. The carrier could be added onto the highly porous support prior to addition of the catalytically active metal, for example by impregnation. Additionally or alternatively, the catalytically active metal and carrier material could be admixed and then added to the highly porous support.

A suitable catalyst comprises cobalt as the catalytically active metal and zirconium as a promoter. Another suitable catalyst comprises cobalt as the catalytically active metal and manganese and/or vanadium as a promoter.

In one embodiment, the highly porous support used in a method according to the present invention has a size in the range of between 1 mm to 50 mm, preferably 1 mm to 30 mm.

In one embodiment, the highly porous support used in a method according to the present invention is larger than 50 mm, for example up to 500 mm, even up to 2 m. Preferably the highly porous support has a size in the range of between 50 mm to 2 m, preferably 50 cm to 1 m.

When of sufficient size, the highly porous catalyst can be fixed in a reactor.

The catalyst according to the present invention can be used for other exothermic processes including hydrogenation, hydroformylation, alkanol synthesis, the preparation of aromatic urethanes using carbon monoxide, Kölbel-Engelhard synthesis, and polyolefin synthesis.

In a Fischer-Tropsch reaction, syngas is converted to hydrocarbons. The conversion products may be in the liquid phase, or partial liquid and partial gas phase under reactor operating conditions.

The Fischer-Tropsch reaction is preferably carried out at a temperature in the range from 125 to 400° C., more preferably 175 to 300° C., most preferably 200 to 260° C. The pressure preferably ranges from 5 to 150 bar, more preferably from 20 to 80 bar. The gaseous hourly space velocity may vary within wide ranges and is typically in the range from 500 to 10000 Nl/l/h, preferably in the range from 1500 to 4000 Nl/l/h. The hydrogen to CO ratio of the feed as it is fed to the catalyst bed generally is in the range of 0.5:1 to 2:1.

Products of the Fischer-Tropsch synthesis may range from methane to heavy hydrocarbons. Preferably, the production of methane is minimised and a substantial portion of the hydrocarbons produced have a carbon chain length of a least 5 carbon atoms. Preferably, the amount of C₅+ hydrocarbons is at least 60% by weight of the total product, more preferably, at least 70% by weight, even more preferably, at least 80% by weight, most preferably at least 85% by weight. The CO conversion of the overall process is preferably at least 50%.

The present invention further relates to a Fischer-Tropsch process comprising the steps of:
(i) providing a Fischer-Tropsch reactor with a catalyst according to the invention;
(ii) supplying syngas to the catalyst;
(iii) removing Fischer-Tropsch product from the reactor.

The present invention is illustrated by the following example, without being limited thereto or thereby.

### Example 1

### Comparative Example

Highly porous metal supports with a size of 90 mm by 70 mm were dipped in a slurry comprising water, titania, and a dispersant. The LOI of the slurry was 71%. The supports were removed from the slurry.

Some of the slurry that was stuck to the support was removed by centrifugation or by spinning for 2 seconds. Centrifugation was performed using a centrifuge with a diameter of 50 cm. Spinning around the axis of the support was performed using a stirring rod or drill.

The support with titania was then dried at 80° C. for 1 hour and subsequently calcined at 535° C. for 30 minutes.

This application method was repeated until the support with titania comprised about 10 to 12 weight % titania, calculated on the total weight of the support with titania. The last calcination step was performed at 535° C. for 2 hours.

The number of repetitions and the total amount of coating obtained in Examples 1 are summarized in Table 1.

For all samples in Example 1 it was noted that over the cross section of the gauze bodies in a horizontal plane, the deposited layer of water and titania did not become equally distributed.

TABLE 1

| | | | Number of |
|---|---|---|---|
| | | | repetitions of |
| | Rotations per | End volume % | the application |
| Examples | minute | of titania | method |
| 1a | 2000 spinning | 12 | 5 |
| | around own axis | | |
| 1b | 866 | 10 | 6 |
| | (50 cm diameter | | |
| | centrifuge) | | |
| 1c | 1076 | 10 | 9 |
| | (50 cm diameter | | |
| | centrifuge) | | |

### Example 2

### According to Invention

Highly porous metal gauze bodies were dipped in a mixture comprising water and titania. Then the gauze bodies were placed in a device according to FIG. 1.

In this case the holders (1) were hanging at the underside of the rotating wheel (2). The rotating wheel (2) was spinning around its own axis, i.e. primary spinning centre (3), clockwise at a speed in the range of 100 to 400 rpm. The holders (1) were spinning around their own axis, i.e. secondary spinning centre (4), clockwise at a speed in the range of 300 to 1200 rpm.

The metal gauze bodies in the holders (1) were moving with the centrifugation movement of the wheel (centrifugation of the metal gauze bodies) and rotating around their own axis (spinning of the metal gauze bodies). The rotating speed of the inner parts of the metal gauze bodies due to the centrifugation of the wheel was in the range of 3 to 10 meter per second. The rotating speed at the outside of the metal gauze bodies due to the rotation around their own axis was in the range of 0.5 to 2 meter per second.

By using the centrifugation and spinning at the same time, the deposited layer of water and titania became more or less equal over the cross section of the gauze bodies in a horizontal plane. The deposited layers resulting from Example 2 thus were better spread out over the metal gauze bodies as compared to the layers deposited in Example 1.

What is claimed is:

1. A method for applying a layer comprising a carrier material to a highly porous support, said method comprising the following steps:
(a) applying a mixture comprising a liquid and a carrier material to a highly porous support having a size of at least 1 mm and a porosity within the range of between 50 and 98 volume %;
(b) centrifuging and spinning the support;
(c) drying and/or calcining the support.

2. A method according to claim 1, wherein the liquid is water or alcohol.

3. A method according to claim 1, wherein the carrier material is a porous metal oxide.

4. A method according to claim 1, wherein the highly porous support has a form or shape selected from the group consisting of gauze, honeycomb, monolith, sponge, mesh, webbing, foil construct and woven mat form, or any combination of these.

5. A method according to claim 1, wherein the highly porous support is made from a metal.

6. A method according to claim 1, wherein the centrifuging and spinning is performed at the same time.

7. A method according to claim 6, wherein the speed of centrifuging is in the range of between 200 and 5000 rpm, and the speed of the spinning is in the range of between 50 and 2000 rpm.

8. A catalyst prepared according to claim 1.

9. A catalyst prepared according to claim 1 wherein the mixture used in step (a) additionally comprises a catalytically active metal or precursor therefor.
